(19) United States
(12) Patent Application Publication
(10) Pub. No.: US 2018/0021932 A1
(43) Pub. Date: Jan. 25, 2018

(54) VIBRATION DAMPING HANDLE ASSEMBLY

(71) Applicant: Mid-Western LLC, Wentzville, MO (US)

(72) Inventors: Bob Bristow, Wentzville, MO (US); Forest Van Dorn, Osburn, ID (US)

(21) Appl. No.: 15/656,710

(22) Filed: Jul. 21, 2017

Related U.S. Application Data
(60) Provisional application No. 62/365,989, filed on Jul. 23, 2016.

(51) Int. Cl. B25D 17/04

(52) U.S. Cl. CPC B25D 17/04; B25D 9/00

(57) ABSTRACT

A vibration damping handle assembly is disclosed which has a control handle having an indentation formed therein, an insert adapted for fitting into the indentation formed in the control handle, an adapter sleeve having an exterior surface and an interior surface having an indentation formed in the interior surface with the indentation adapted for receiving the insert fitted into the indentation formed in the control handle, and an outer sleeve member for fitting on the exterior surface of the adapter sleeve.

### RELATED APPLICATION

This application claims priority to U.S. Provisional Patent Application Ser. No. 62/365,989, filed on Jul. 23, 2016, the disclosure of which is incorporated herein by reference.

### BACKGROUND

This disclosure relates generally to a handle for a rock drill, and more particularly to a vibration damping handle assembly for a rock drill.

Hydraulic and pneumatic tools or drills are used to quickly drill or cut through hard materials such as concrete or rock. One drill, known as a rock drill, is used to drill or hammer through rock or stone to produce holes into which a blasting material may be inserted to blast away the rock or stone. These drills are bulky, heavy, and create vibrations. If the vibrations are violent enough, the rock drill may be difficult for an operator to handle and use. Over prolonged use of such vibrating tools or drills the vibrations can also cause injury and damage to the hands, wrists, arms, and body of the operator. It is known that over extended periods of use of the rock drill, the operator may lead to HAVS (hands arms vibration syndrome), Raynaud's disease, and CTS (carpal tunnel syndrome). In view of this, it would be desirable to reduce or eliminate any vibrations felt or absorbed by the operator of a hydraulic or pneumatic tool or drill.

The present disclosure of a vibration damping handle assembly is designed to obviate and overcome many of the disadvantages and shortcomings experienced with using a hydraulic or pneumatic tool. Moreover, the present disclosure is related to a vibration damping handle assembly that reduces or eliminates any harmonic resonance in a handle assembly to increase comfort and the duration that an operator can handle or operate the rock drill. The vibration damping handle assembly of the present disclosure is also simple to use and automatically reduces or eliminates any vibrations without requiring any operator intervention.

### SUMMARY

In one form of the present disclosure, a vibration damping handle assembly is disclosed which comprises a control handle having an indentation formed therein, an insert adapted for fitting into the indentation formed in the control handle, an adapter sleeve having an exterior surface and an interior surface having an indentation formed in the interior surface with the indentation adapted for receiving the insert fitted into the indentation formed in the control handle, and an outer sleeve member for fitting on the exterior surface of the adapter sleeve.

In another form of the present disclosure, a vibration damping handle assembly is disclosed which comprises a control handle having a first end having an indentation formed therein, an insert adapted for fitting into the indentation formed in the control handle, an adapter sleeve having an exterior surface and an interior surface having an indentation formed in the interior surface with the indentation adapted for receiving the insert fitted into the indentation formed in the first end of the control handle, and an outer sleeve member for fitting on the exterior surface of the adapter sleeve.

In still another form of the present disclosure, a vibration damping handle assembly is disclosed which comprises a control handle having a number of indentations formed therein, a number of inserts with each insert adapted for fitting into one of the number of the indentations formed in the control handle, an adapter sleeve having an exterior surface and an interior surface having a number of indentations formed in the interior surface with each of the indentation adapted for receiving one of the number of inserts fitted into the indentations formed in the control handle, and an outer sleeve member for fitting on the exterior surface of the adapter sleeve.

In light of the foregoing comments, it will be recognized that the vibration damping handle assembly of the present disclosure reduces or eliminates transmission of vibrations from a rock drill to the hands and upper limbs of an operator of the rock drill.

The present disclosure provides a vibration damping handle assembly that may be used to increase the comfort level of operating a rock drill.

The present disclosure provides a vibration damping handle assembly that does not require any operator intervention to reduce or eliminate any harmonic resonance in grasping or holding a handle associated with a rock drill.

The present disclosure provides a vibration damping handle assembly that increases the time that an operator can handle or operate the rock drill.

The present disclosure is directed to a vibration damping handle assembly that greatly reduces any injuries or symptoms related to prolonged use of a vibrating tool.

The present disclosure also provides a vibration damping handle assembly that be easily employed with highly reliable results.

The present disclosure further provides a vibration damping handle assembly that is sturdy and capable of withstanding extended use in a harsh work environment such as a mine.

The present disclosure provides a vibration damping handle assembly that can be constructed using readily available materials and easily manufactured components.

The present disclosure also provides a vibration damping handle assembly that that may be used with existing rock drills and does not require retrofitting existing rock drills.

These and other advantages of the present disclosure will become apparent after considering the following detailed specification in conjunction with the accompanying drawings, wherein:

### BRIEF DESCRIPTION OF THE DRAWINGS

FIG. 1 is a front view of a vibration damping handle assembly constructed according to the present disclosure installed on a rock drill;

FIG. 2 is a top exploded view of the vibration damping handle assembly removed from the rock drill;

FIG. 3 is a side view of the vibration damping handle assembly;

FIG. 4 is an exploded view of the vibration damping handle assembly;

FIG. 5 is a cross-sectional view of the vibration damping handle assembly taken along the plane of 5-5 in FIG. 3;

FIG. 6 is a side view of a control handle of the vibration damping handle assembly constructed according to the present disclosure;

FIG. 7 is a cross-sectional view of an adapter sleeve of the vibration damping handle assembly constructed according to the present disclosure;

FIG. 8 is a side view of an insert of the vibration damping handle assembly constructed according to the present disclosure; and

FIG. 9 is a side view of outer sleeve member of the vibration damping handle assembly constructed according to the present disclosure shown partially in phantom.

### DETAILED DESCRIPTION OF THE PREFERRED EMBODIMENTS

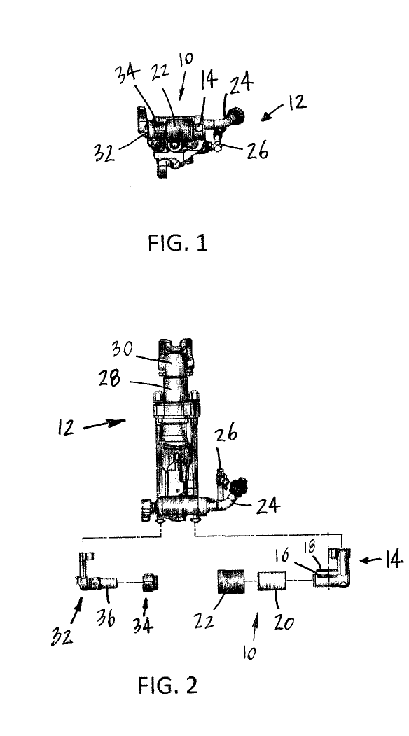

Referring now to the drawings, wherein like numbers refer to like items, number 10 identifies a preferred embodiment of a vibration damping handle assembly constructed according to the present disclosure. With reference now to FIGS. 1 and 2, the vibration damping handle assembly 10 is shown being connected to a hydraulic rock drill 12, such as a jackleg drill. The rock drill 12 may be used to drill out rock in mining applications. The vibration damping handle assembly 10 comprises a control handle 14 having an indentation 16 formed therein, a spline or insert 18, an adapter sleeve 20, and an outer sleeve member 22. Although only one indentation 16 and one insert 18 are shown, as will be explained in detail further herein, there may be multiple indentations formed in the control handle 14 and multiple inserts placed in each of the multiple indentations. As can be appreciated, the vibration damping handle assembly 10 is grasped by an operator of the rock drill 12 along or around the outer sleeve member 22 to hold or steady the rock drill 12 during use. The rock drill 12 may include other components such as an air connection assembly 24, a water connection assembly 26, a cylinder 28, and a chuck end 30. The rock drill 12 also has a control handle portion 32 having a feed control sleeve or throttle 34 mounted thereon. The control handle 14 and the control handle portion 32 are mounted to the rock drill 12. The control handle portion 32 has an end section 36 that fits into the adapter sleeve 20.

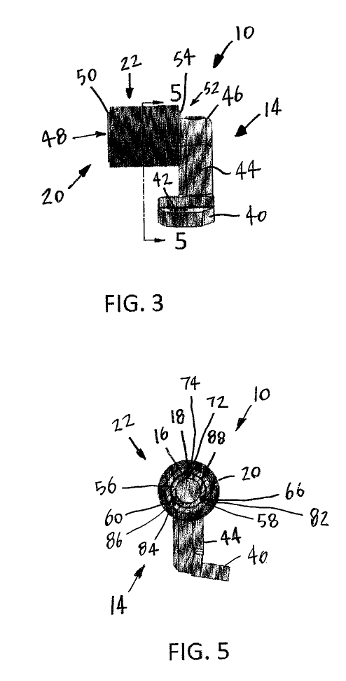

Referring now to FIG. 3, a side view of the vibration damping handle assembly 10 is shown. The assembly 10 has the control handle 14 that has a flange member 40 having an aperture 42. The flange member 40 is connected to an intermediate section 44 which is connected to a top section 46. The adapter sleeve 20 is shown having a first end 48 having a stop or flange 50 and a second end 52 also having a stop or flange 54. The outer sleeve member 22 is shown being placed over or on the adapter sleeve 20 between the stops 50 and 54. The outer sleeve member 22 is constructed of a resilient material such as rubber or neoprene.

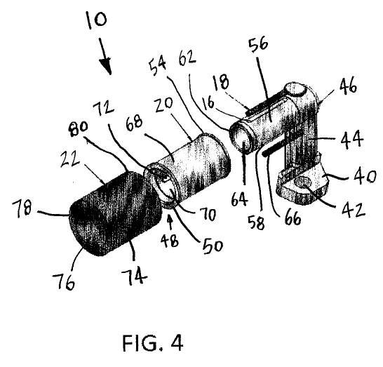

FIG. 4 illustrates an exploded perspective view of the vibration damping handle assembly 10. The vibration damping handle assembly 10 has the control handle 14 having the flange member 40, the aperture 42 formed in the flange member 40, the intermediate section 44, and the top section 46. Extending out from the top section 46 is an end section 56 having the indentation 16 formed therein and a second indentation 58 also formed therein. Although the two indentations 16 and 58 are shown in this particular view, it is contemplated that another indentation 60 (FIG. 5) is formed in the end section 56, as will be shown further herein. The end section 56 has an opening 62 and a lumen or cavity 64. The insert 18 is shown being sized and shaped to fit into the indentation 16. Another insert 66 is also shown and it is sized and shaped to fit into the second indentation 58. The inserts 18 and 66 may be constructed of neoprene rubber. The adapter sleeve 20 has an exterior surface 68 and an interior surface 70 having an indentation 72 formed therein. The indentation 72 is sized and shaped to receive the insert 18 when the adapter sleeve 20 is inserted over the end section 56 of the control handle 14. As can be appreciated, the adapter sleeve 20 is a hollow cylinder that allows the adapter sleeve 20 to be slide over the end section 56 of the control handle 14. The outer sleeve member 22 has an exterior surface 74, an interior surface 76, a first end 78, and a second end 80. The outer sleeve member 22 is also a hollow cylinder that is adapted to be placed on or over the adapter sleeve 20 between the stops 50 and 54.

With particular reference now to FIG. 5, a portion of the vibration damping handle assembly 10 is depicted in cross-section. The assembly 10 is shown having the flange member 40 and the intermediate section 44. The outer sleeve member 22 is inserted on the adapter sleeve 20. The adapter sleeve 20 also has a second indentation 82 and a third indentation 84 formed in the interior surface 70. The inserts 18 and 66 are inserted into the indentations 16 and 72 and 58 and 82, respectively. A third insert 86 is also inserted into the indentations 60 and 84. Although three inserts 18, 66, and 86, three indentations 16, 58, and 60 in the end section 56, and three indentations 66, 72, and 84 are shown, it is possible and contemplated that more inserts and indentations may be employed. Further, the indentations 16, 58, and 60 are equally spaced around the end section 56. The indentations 66, 72, and 84 are also equally spaced around the interior surface 70 of the adapter sleeve 20. With the inserts 16, 58, and 60 in place there is a space or a gap formed between the adapter sleeve 20 and the end section 56.

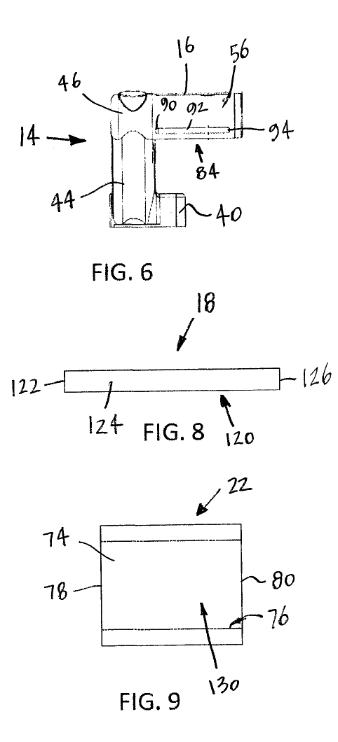

FIG. 6 is a side view of the control handle 14 of the vibration damping handle assembly 10. The control handle 14 has the flange member 40, the intermediate section 44, the top section 46, and the end section 56. The indentations 16 and 84 are visible in this particular view. The indentation 84 is shown to have a first rounded or radius end 90, an intermediate section 92, and a second rounded or radius end 94. The insert 86 (not shown) may be placed or positioned in the intermediate section 92 and may expand into the ends 90 and 94 when in use.

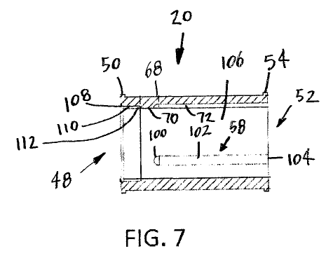

Referring now to FIG. 7, a cross-sectional view of the adapter sleeve 20 is illustrated. The adapter sleeve 20 has the first end 48 having the stop or flange 50 and the second end 52 also having the stop or flange 54. The adapter sleeve 20 also has the exterior surface 68 and the interior surface 70. The interior surface 70 has the indentations 58 and 72 formed therein. The indentation 58 has a first rounded or radius end 100, an intermediate section 102, and a flat end 104 that extends to the second end 52. Having the flat end 104 extend to the second end 52 assists in placing the adapter sleeve 20 on the end section 56 (not shown) and the insert 66 (also not shown). In this manner, the adapter sleeve 20 can be easily slid or slipped into place on the insert 66 and around the end section 56. As can be appreciated, the intermediate section 102 is sized and shaped to capture or hold the insert 66. Also, the rounded end 100 allows for any expansion of the insert 66 during use. The indentation 72 is formed similar to the indentation 58. The adapter sleeve 20 also has a lumen or cavity 106 formed therein for receiving the end section 56 therein. The first end 48 has an interior tapered edge 108, an intermediate section 110, and a stop edge 112. The first end 48 is adapted to receive the end section 36 of the control handle portion 32 (FIG. 2). The stop edge 112 prevents the end section 36 from entering too far into the lumen 106.

FIG. 8 is a side view of the insert 18. The insert 18 has a rod or cylinder like body 120 having a first flat end 122, an intermediate section 124, and a second flat end 126. The insert 18 is constructed of neoprene rubber. The other inserts 66 and 86 are constructed in the same manner. The flat ends 122 and 126 allow the insert 18 to expand.

With reference now to FIG. 9, a side view of the outer sleeve member 22 shown partially in phantom is shown. The outer sleeve member 22 has tubular body 130 having the exterior surface 74, the interior surface 76, the first end 78, and the second end 80. The outer sleeve member 22 may be placed on or over the adapter sleeve 20 and the first end 78 contacts the stop 50 (FIG. 3) and the second end 80 contacts the stop 54 (FIG. 3). In this manner the outer sleeve member 22 is securely positioned on the adapter sleeve 20. The outer sleeve member 22 may be constructed of neoprene rubber. As can be appreciated, since the outer sleeve member 22 may wear due to use of the assembly 10, the outer sleeve member 22 may be easily replaced with a new outer sleeve member 22.

From all that has been said, it will be clear that there has thus been shown and described herein a vibration damping handle assembly which fulfills the various objects and advantages sought therefor. It will be apparent to those skilled in the art, however, that many changes, modifications, variations, and other uses and applications of the subject vibration damping handle assembly are possible and contemplated. All changes, modifications, variations, and other uses and applications which do not depart from the spirit and scope of the disclosure are deemed to be covered by the disclosure, which is limited only by the claims which follow.

What is claimed is:

1. A vibration damping handle assembly comprising:
a control handle having an indentation formed therein;
an insert adapted for fitting into the indentation formed in the control handle;
an adapter sleeve having an exterior surface and an interior surface having an indentation formed in the interior surface with the indentation adapted for receiving the insert fitted into the indentation formed in the control handle; and
an outer sleeve member for fitting on the exterior surface of the adapter sleeve.

2. The vibration damping handle assembly of claim 1 wherein the insert comprises neoprene rubber.

3. The vibration damping handle assembly of claim 1 wherein the control handle is connected to a rock drill.

4. The vibration damping handle assembly of claim 1 wherein the outer sleeve member comprises rubber.

5. The vibration damping handle assembly of claim 1 wherein the outer sleeve member has a length for allowing an operator to grasp the length of the outer sleeve member.

6. The vibration damping handle assembly of claim 1 further comprising a control handle portion having an end section and a feed control sleeve with the end section for fitting into the adapter sleeve.

7. A vibration damping handle assembly comprising:
a control handle having a first end having an indentation formed therein;
an insert adapted for fitting into the indentation formed in the control handle;
an adapter sleeve having an exterior surface and an interior surface having an indentation formed in the interior surface with the indentation adapted for receiving the insert fitted into the indentation formed in the first end of the control handle; and
an outer sleeve member for fitting on the exterior surface of the adapter sleeve.

8. The vibration damping handle assembly of claim 7 wherein the insert comprises neoprene rubber.

9. The vibration damping handle assembly of claim 7 wherein the control handle is connected to a rock drill.

10. The vibration damping handle assembly of claim 7 wherein the outer sleeve member comprises rubber.

11. The vibration damping handle assembly of claim 7 further comprising a control handle portion having an end section and a feed control sleeve with the end section for fitting into the adapter sleeve.

12. The vibration damping handle assembly of claim 7 wherein the adapter sleeve further comprises a first end have a stop edge and a second end having a stop edge and the outer sleeve member fits on the exterior surface of the adapter sleeve between the stop edges.

13. The vibration damping handle assembly of claim 7 wherein .

14. A vibration damping handle assembly comprising:
a control handle having a number of indentations formed therein;
a number of inserts with each insert adapted for fitting into one of the number of the indentations formed in the control handle;
an adapter sleeve having an exterior surface and an interior surface having a number of indentations formed in the interior surface with each of the indentation adapted for receiving one of the number of inserts fitted into the indentations formed in the control handle; and
an outer sleeve member for fitting on the exterior surface of the adapter sleeve.

15. The vibration damping handle assembly of claim 14 wherein each of the inserts comprises neoprene rubber.

16. The vibration damping handle assembly of claim 14 wherein the number of indentations formed in the control handle is three.

17. The vibration damping handle assembly of claim 14 wherein the number of inserts is three.

18. The vibration damping handle assembly of claim 14 wherein the number of indentations formed in the adapter sleeve is three.

19. The vibration damping handle assembly of claim 14 wherein the control handle is connected to a rock drill.

20. The vibration damping handle assembly of claim 14 further comprising a control handle portion having an end section and a feed control sleeve with the end section for fitting into the adapter sleeve.
